(19) United States
(12) Patent Application Publication
(10) Pub. No.: US 2020/0049910 A1
(43) Pub. Date: Feb. 13, 2020

(54) OPTICAL CONNECTING DEVICE

(71) Applicant: Sumitomo Electric Industries, LTD., Osaka (JP)

(72) Inventors: Mitsuharu Hirano, Osaka (JP); Akira Furuya, Osaka (JP)

(73) Assignee: Sumitomo Electric Industries, LTD., Osaka (JP)

(21) Appl. No.: 16/528,902

(22) Filed: Aug. 1, 2019

(30) Foreign Application Priority Data
Aug. 10, 2018 (JP) 2018-151484

(51) Int. Cl. G02B 6/42; G02B 6/38; F21V 8/00

(52) U.S. Cl. CPC G02B 6/4239; G02B 6/3839; G02B 6/3885; G02B 6/4281; G02B 6/0083; G02B 6/4243; G02B 6/426

(57) ABSTRACT

An optical connecting device includes a holder including a first component including a first outer part having a first ridge, a second outer part having a second ridge and an inner part having a bottom of a recess being defined by the first ridge and the second ridge, a second component being located between the first ridge of the first outer part and the second ridge of the second outer part, and an adhesive member being provided between the first component and the second component; and a plurality of optical fibers being arrayed between the bottom of the first component and the second component, wherein the optical fibers, the first ridge, and the second ridge extend in a direction of a first axis, and the first outer part, the inner part, and the second outer part are arrayed in a direction of a second axis crossing the first axis.

### CROSS REFERENCE TO RELATED APPLICATIONS

The present application is based upon and claims the benefit of the priority from Japanese patent application No. 2018-151484, filed on Aug. 10, 2018, which is hereby incorporated by reference in its entirety.

### TECHNICAL FIELD

The present disclosure relates to an optical connecting device.

### BACKGROUND

Japanese Patent Application Laid-Open No. 2003-337245 discloses a substrate for arraying optical fibers. This substrate has, on a principal surface thereof, V-shaped grooves and side grooves which are different from the V-shaped grooves.

### SUMMARY

The present disclosure provides an optical connecting device comprising: a holder including a first component including a first outer part having a first ridge, a second outer part having a second ridge and an inner part having a bottom of a recess being defined by the first ridge and the second ridge, a second component being located between the first ridge of the first outer part and the second ridge of the second outer part, and an adhesive member being provided between the first component and the second component; and a plurality of optical fibers being arrayed between the bottom of the first component and the second component, wherein the optical fibers, the first ridge, and the second ridge extend in a direction of a first axis, and the first outer part, the inner part, and the second outer part are arrayed in a direction of a second axis crossing the first axis.

### BRIEF DESCRIPTION OF THE DRAWINGS

The foregoing and other purposes, aspects and advantages will be better understood from the following detailed description of a preferred embodiment of the invention with reference to the attached drawings.

FIG. 1A is a front view schematically illustrating an optical connecting device according to the present embodiment.

FIG. 1B is a top view schematically illustrating an optical connecting device according to the present embodiment.

FIG. 1C is a rear view schematically illustrating an optical connecting device according to the present embodiment.

FIG. 1D is a view schematically illustrating an optical fiber for the optical connecting device according to the present embodiment.

FIG. 2A is a plan view illustrating a first component for a holder according to the present embodiment.

FIG. 2B is a side view illustrating a first component according to the present embodiment.

FIG. 2C is a view illustrating a cross section taken along line IIc-IIc shown in FIG. 2A.

FIG. 2D is a front view illustrating a first component according to the present embodiment.

FIG. 2E is a front view illustrating a second component for a holder according to the present embodiment.

FIG. 2F is a side view illustrating a second component according to the present embodiment.

FIG. 3A is a plan view illustrating the first component for the holder according to the present embodiment.

FIG. 3B is a side view illustrating the first component according to the present embodiment.

FIG. 3C is a view illustrating a cross section taken along line IIIc-IIIc shown in FIG. 3A.

FIG. 3D is a front view illustrating the first component according to the present embodiment.

FIG. 3E is a front view illustrating the second component for the holder according to the present embodiment.

FIG. 3F is a side view illustrating the second component according to the present embodiment.

FIG. 4A is a view illustrating a first ridge and a second ridge of the first component and the second component according to the present embodiment.

FIG. 4B is a view illustrating a first ridge and a second ridge of the first component and the second component according to the present embodiment.

FIG. 4C is a view illustrating a first ridge and a second ridge of the first component and the second component according to the present embodiment.

FIG. 5A is a view illustrating the optical connecting device according to the present embodiment.

FIG. 5B is a view illustrating the optical connecting device according to the present embodiment.

FIG. 5C is a view illustrating the optical connecting device according to the present embodiment.

FIG. 5D is a view illustrating an optical device according to the present embodiment.

FIG. 6 is a view illustrating the optical connecting device and the optical device according to the present embodiment.

FIG. 7A is a plan view illustrating a first member and an optical fiber component for the optical connecting device.

FIG. 7B is a view illustrating a cross section taken along line VIIb-VIIb shown FIG. 7A.

FIG. 7C is a view illustrating a cross section taken along line VIIc-VIIc shown in FIG. 7A.

FIG. 7D is a plan view illustrating a second member for the optical connecting device.

FIG. 8A is a plan view illustrating the first member, the second member, and the optical fiber component which are preliminarily assembled.

FIG. 8B is a view illustrating a cross section taken along line VIIIb-VIIIb shown in FIG. 8A.

FIG. 8C is a view illustrating a cross section taken along a line VIIIc-VIIIc shown in FIG. 8A.

FIG. 9A is a plan view illustrating the first member, the second member, and the optical fiber component which are fixed by the adhesive.

FIG. 9B is a view illustrating a cross section taken along line IXb-IXb shown in FIG. 9A.

FIG. 9C is a view illustrating a cross section taken along line IXc-IXc shown in FIG. 9A.

FIG. 10A is a plan view illustrating an optical connecting device processed by machining.

FIG. 10B is a view illustrating a cross section taken along line Xb-Xb shown in FIG. 10A.

FIG. 10C is a view illustrating a cross section taken along line Xc-Xc shown in FIG. 10A.

### DETAILED DESCRIPTION

### Problem to be Solved by the Present Disclosure

According to the findings by the inventors, when an amount of an adhesive is somewhat larger, not only are the side grooves filled with the adhesive but the adhesive also overflows therefrom. When the amount of the adhesive is somewhat smaller, all of portions of the optical fibers which are desired to be covered with the adhesive cannot be covered therewith and a desired adhesion strength cannot be attained.

### Advantageous Effect of the Present Disclosure

According to the present disclosure, the optical connecting device having the structure which allows the adhesive, which fixes the optical fibers, the first component, and the second component, to be disposed in the areas where the optical fibers are arrayed can be provided.

### Description of Embodiments of the Present Disclosure

Several specific examples will be described.

An optical connecting device according to a specific example comprises: (a) a holder which includes a first component including a first outer part having a first ridge, a second outer part having a second ridge and an inner part having a bottom of a recess defined by the first ridge and the second ridge, a second component located between the first ridge of the first outer part and the second ridge of the second outer part, and an adhesive member provided between the first component and the second component; and (b) a plurality of optical fibers which are arrayed between the bottom of the first component and the second component. The optical fibers, the first ridge, and the second ridge extend in a direction of a first axis, and the first outer part, the inner part, and the second outer part are arrayed in a direction of a second axis which crosses the first axis.

According to the optical connecting device, the adhesive member is provided between the first component and the second component and extends along inner side surfaces of the first ridge and the second ridge and a first side surface and a second side surface of the second component.

In the optical connecting device according to the specific example, the first component has a plurality of grooves, which extend in the direction of the first axis, in the bottom of the recess, the second component has a supporting surface, and the optical fibers are positioned by the grooves of, the first component and the supporting surface of the second component.

According to the optical connecting device, the array of the grooves of the first component orients the optical fibers. The second component holds the optical fibers by the supporting surface thereof.

In the optical connecting device according to the specific example, the first component has a step difference which terminates the grooves, the inner part of the first component has a first area and a second area which are arrayed in the direction of the first axis, the step difference has a sloping surface which connects the first area to the second area, the second component is located on the first area, and each of the optical fibers has a first fiber part which extends between the first area of the first component and the second component of the holder and a second fiber part which extends in the second area of the holder.

According to the optical connecting device, each of the optical fibers is separated from the second area of the first component and the second component. This separation reduces stress which the optical fibers receive by thermal deformation of the first component and the second component.

In the optical connecting device according to the specific example, the optical fibers are arrayed along a first reference surface which crosses a third axis crossing the first axis and the second axis, the holder has a front end surface which extends along a second reference surface crossing the first reference surface, the first component and the second component extend in the direction of the first axis from the front end surface, and each of the optical fibers has an end portion which is located on the front end surface.

According to the optical connecting device, the array of the end portions of the optical fibers is optically coupled to an external device.

In the optical connecting device according to the specific example, the optical fibers are arrayed along a first reference surface which crosses a third axis crossing the first axis and the second axis, the holder has a front end surface which extends along a second reference surface inclining with respect to the first reference surface, each of the optical fibers has the end portion which is located on the front end surface, each of the optical fibers has a clad end surface extending along the third reference surface which crosses the first axis, the clad end surface being away from the end portion, and each of the optical fibers has a clad side surface extending along a fourth reference surface crossing the first axis, the clad side surface being away from the end portion.

According to the optical connecting device, the array of the end portions of the optical fibers is optically coupled via the clad side surface to the external device.

### Detailed Description of the Embodiments of the Present Disclosure

The findings of the present disclosure can be easily understood by considering the following detailed description with reference to the accompanying drawings illustrated as examples. Subsequently, with reference to the accompanying drawings, an embodiment of an optical connecting device and a method for manufacturing the optical connecting device will be described. Where possible, the same parts are denoted by the same reference numerals and signs.

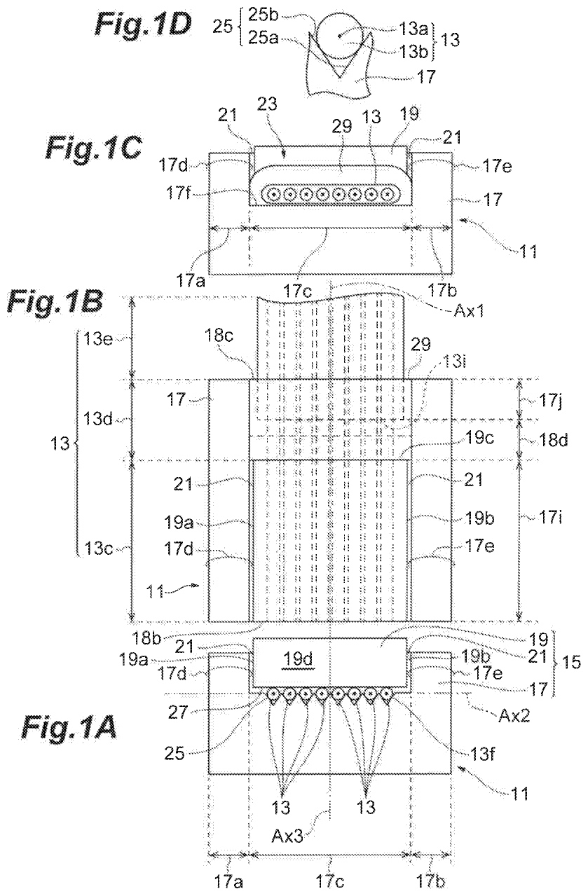

FIG. 1A is a front view schematically illustrating the optical connecting device according to the present embodiment. FIG. 1B is a top view schematically illustrating the optical connecting device according to the present embodiment. FIG. 1C is a rear view schematically illustrating the optical connecting device according to the present embodiment. FIG. 1D is a view schematically illustrating an optical fiber for the optical connecting device according to the present embodiment

The optical connecting device 11 comprises one or a plurality of optical fibers 13 and a holder 15. The holder 15 includes a first component 17, a second component 19, and an adhesive member 21. The adhesive member 21 is provided between the first component 17 and the second component 19. Each of the optical fibers 13 has a core 13a and a clad 13b and can be a single-mode fiber formed of quartz, for example.

The first component 17 includes a first outer part 17a, a second outer part 17b, and an inner part 17c. The first outer part 17a and the second outer part 17b includes a first ridge 17d and a second ridge 17e, respectively. The optical fibers 13, the first outer part 17a, the second outer part 17b, and the inner part 17c extend in a direction of a first axis Ax1. The first outer part 17a, the inner part 17c, and the second outer part 17b are arrayed in a direction of a second axis Ax1 which crosses the first axis Ax1. The inner part 17c has a bottom 17f of a recess 23 which is defined by the first ridge 17d and the second ridge 17e.

The second component 19 is located between the first ridge 17d of the first outer part 17a and the second ridge 17e of the second outer part 17b. The optical fibers 13 are arrayed between the bottom 17f of the recess 23 and the second component 19.

According to the optical connecting device 11, the adhesive member 21 is provided between the first component 17 and the second component 19 and extends in the first axis Ax1 and the direction of the second axis Ax2 along a first inner side surface 17g of the first ridge 17d and a second inner side surface 17h of the second ridge 17e as well as a first side surface 19a and a second side surface 19b of the second component 19. The adhesive member 21 is provided between the bottom 17f of the first component 17 and the second component 19, between the first inner side surface 17g of the first ridge 17d and the first side surface 19a of the second component 19, and between the second inner side surface 17h of the second ridge 17e and the second side surface 19b of the second component 19 and fixes the optical fibers 13, the first component 17, and the second component 19. The first component 17 and the second component 19 are fixed, and as a result, the optical fibers 13 are positioned between the first component 17 and the second component 19.

In the present example, the first component 17 has a plurality of grooves 25 which extend in the direction of the first axis Ax1. The grooves 25 are provided on the bottom 17f of the recess 23. The second component 19 has a supporting surface 27 which is substantially flat. The optical fibers 13 are positioned by the grooves 25 of the first component 17 and are positioned by holding made by the supporting surface 27 of the second component 19. Where needed, instead of the first component 17, the second component 19 can comprise the grooves 25, and instead of the second component 19, the first component 17 can comprise the supporting surface 27 which is substantially flat.

According to the optical connecting device 11, the grooves 25 of the first component 17 orient the optical fibers 13 in the direction of the first axis Ax1 and position the optical fibers 13 in a direction of a third axis Ax3 which crosses the first axis Ax1 and the second axis Ax2.

The second component 19 holds the optical fibers 13 by the supporting surface 27 thereof in the direction of the third axis Ax3.

Specifically, each of the grooves 25 has a first supporting surface 25a and a second supporting surface 25b which support each of the optical fibers 13 and include V-shaped grooves in the present example.

The optical connecting device 11 further comprises a resin body 29 which fixes the optical fibers 13 in the first component 17. The resin body 29 covers the optical fibers 13 between a rear end surface 19c of the second component 19 and a rear end 18c of the first component 17. The resin body 29 which encloses the optical fibers 13 hinders the optical fibers 13, which may be bent by an external force, from contacting the first component 17 and the second component 19.

According to the optical connecting device 11, the optical fibers 13 contact with the first component 17 and the second component 19 between these components on a first area 17i and are separated from the first component 17 and the second component 19 on a second area 17j. This separation reduces stress which the optical fibers receive by thermal deformation of the first component 17 and the second component 19. Specifically, each of the optical fibers 13 has a first fiber part 13c which extends between the first area 17i of the first component 17 and the second component 19 of the holder 15 and a second fiber part 13d which extends on the second area 17j of the holder 15, and where needed, can have a third fiber part 13e which extends outside the holder 15.

The resin body 29 reaches the first ridge 17d and the second ridge 17e between the rear end surface 19c of the second component 19 and the rear end 18c of the first component 17.

Specifically, the resin body 29 covers a side surface of the second fiber part 13d and thereby separates the second fiber part 13d from the holder 15 and fixes the second fiber part 13d to the holder 15 and thereby suppresses bending of the optical fibers 13 which receive the external force. The resin body 29 covers resin covering ends 13i of the optical fibers 13 on the second area 17j.

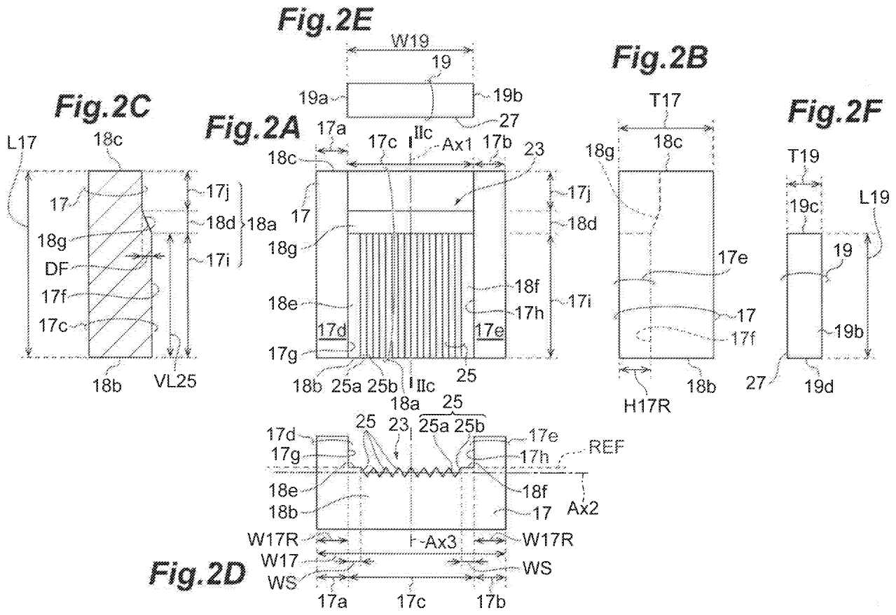

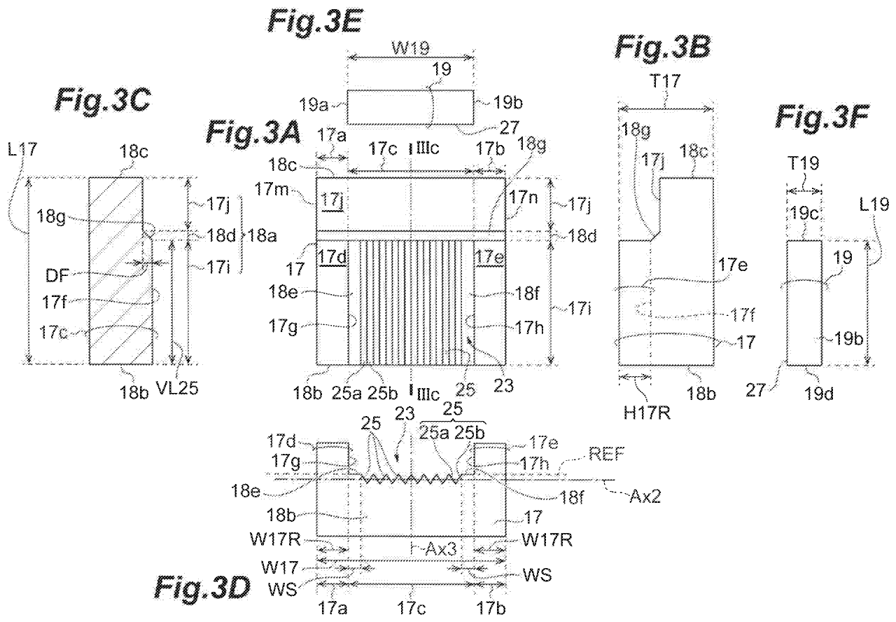

FIG. 2A is a plan view illustrating the first component for the holder according to the present embodiment. FIG. 2B is a side view illustrating the first component according to the present embodiment. FIG. 2C is a view illustrating a cross section taken along line IIc-IIc shown in FIG. 2A. FIG. 2D is a front view illustrating the first component according to the present embodiment. FIG. 2E is a front view illustrating the second component for the holder according to the present embodiment. FIG. 2F is a side view illustrating the second component according to the present embodiment. FIG. 3A is a plan view illustrating the first component for the holder according to the present embodiment. FIG. 3B is a side view illustrating the first component according to the present embodiment. FIG. 3C is a view illustrating a cross section taken along line IIIc-IIIc shown in FIG. 3A. FIG. 3D is a front view illustrating the first component according to the present embodiment. FIG. 3E is a front view illustrating the second component for the holder, according to the present embodiment. FIG. 3F is a side view illustrating the second component according to the present embodiment.

With reference to FIG. 2A, 2B, 2C, 2D, 2E, 2F, 3A, 3B, 3C, 3D, 3E and 3F, the first component 17 has a principal surface 18a, a front end 18b, and the rear end 18c and where needed, can further have the step difference 18d on the principal surface 18a. The second component 19 has the rear end surface 19c which is away from the rear end 18c of the first component 17 and the front end surface 19d which is located opposite to the rear end surface 19c. The second component 19 can be provided on the first area 17i of the first component 17.

In the first component 17, the principal surface 18a has the first area 17i and the second area 17j, and the first area 17i is located in the inner part 17c. The first area 17i, the step difference 18d, and the second area 17j are arrayed in the direction of the first axis Ax1.

The first area 17i extends in the direction of the first axis Ax1 from the font end 18b to the step difference 18d and connects the first inner side surface 17g of the first ridge 17d to the second inner side surface 17h of the second ridge 17e. The grooves 25 are provided in the first area 17i and are terminated at the step difference 18d. The second area 17j can extend in the direction of the first axis Ax1 from the step difference 18d to the rear end 18c. In the present example, the second area 17j is substantially flat.

In the present embodiment, the first area 17i has the grooves 25 which are arrayed in the direction of the second axis Ax2, a first surface 18e which is located between one of two outermost grooves 25 and an lower end of the first inner side surface 17g of the first ridge 17d, and a second flat surface 18f which is located between the other of the two outermost grooves 25 and an lower end of the second inner side surface 17h of the second ridge 17e.

The first surface 18e and the second flat surface 18f extend along a reference surface REF which crosses the third axis Ax3. The first supporting surface 25a and the second supporting surface 25b of each of the grooves 25 are located on a lower side of the reference surface REF, and the first ridge 17d and the second ridge 17e are located on an upper side of the reference surface REF.

In the present embodiment, the step difference 18d has a sloping surface 18g which connects the first area 17i to the second area 17j.

With reference to FIGS. 1A, 1B, 1C, 1D, 2A, 2B, 2C, 2D, 2E and 2F, the first ridge 17d and the second ridge 17e extend from the front end 18b of the first component 17 to the rear end 18c thereof. The second component 19 is terminated in a position which is away from the rear end 18c of the first component 17. The second component 19 has the rear end surface 19c which is away from the rear end 18c of the first component 17 and the front end surface 19d which is located opposite to the rear end surface 19c.

According to the optical connecting device 11, the resin body 29 encloses side surfaces of the optical fibers 13 between the end portion of the second component 19 and the rear end 18c of the first component 17. The resin body 29 which covers the optical fibers 13 avoids contacting of the optical fibers, which are bent by the external force, with the first component 17 and the second component 19.

With reference to FIGS. 1A, 1B, 1C, 1D, 3A, 3B, 3C, 3D, 3E and 3F, the first ridge 17d and the second ridge 17e are terminated in a position which is away from the rear end 18c of the first component 17.

The resin body 29 extend from the first outer part 17a via the inner part 17c to the second outer part 17b between the rear end surface 19c of the second component 19 and the rear end 18c of the first component 17 and fixes the optical fibers 13 to the first component 17. The resin body 29 is away from upper edges of a first outer side surface 17m and a second outer side surface 17n of the first component 17 on the second area 17j. The resin body 29 which encloses each of the optical fibers 13 in a circumferential direction serves to locate the optical fibers 13 in such a way as to be away from the second area 17j of the first component 17 and the second component 19.

As shown in FIGS. 1A, 1B, 1C and 1D, the optical connecting device 11 has a pigtail structure. The present embodiment, however, shall not preclude the optical connecting device from having a stub structure.

Dimensions of the optical connecting device 11 shown in FIGS. 2A, 2B, 2C, 2D, 2E, 2F, 3A, 3B, 3C, 3D, 3E and 3F are as follows.

A length L17 of the first component 17 is in a range of 2 mm to 10 mm and for example, is 5 mm.

A width W17 of the first component 17 is in a range of 2 mm to 10 mm and for example, is 6 mm.

A thickness T17 of the first component 17 is in a range of 1 mm to 3 mm and for example, is 2 mm.

A step difference DF of the first component 17 is in a range of 0.1 mm to 0.5 mm and for example, is 0.3 mm.

A ridge height H17R is in a range of 0.3 mm to 1.5 mm and for example, is 0.5 mm.

A ridge width W17R is in a range of 0.3 mm to 1.5 mm and for example, is 0.8 mm.

A depth of each of the V-shaped grooves (25) is in a range of 0.025 mm to 0.125 mm and for example, is 0.08 mm.

A length VL25 of each of the V-shaped grooves (25) is in a range of 0.5 mm to 8.0 mm and for example, is 4 mm.

A width WS of each of the flat surfaces (18e and 18f) is in a range of 0.05 mm to 1.0 mm and for example, is 0.1 mm.

A length L19 of the second component 19 is in a range of 0.5 mm to 8.0 mm and for example, is 4 mm.

A width W19 of the second component 19 is in a range of 2 mm to 8 mm and for example, is 4 mm.

A thickness T19 of the second component 19 is in a range of 0.5 mm to 2 mm and for example, is 1 mm.

The adhesive member 21 is, for example, an epoxy-based, acrylate-based, or silicone-based member.

The first component 17 can be formed of, for example, glass or ceramic and specifically, of quartz, TEMPAX, PYREX (registered trademark), alumina, or zirconia. The second component 19 can be formed of, for example, glass or ceramic and specifically, of quartz, TEMPAX, PYREX (registered trademark), alumina, or zirconia.

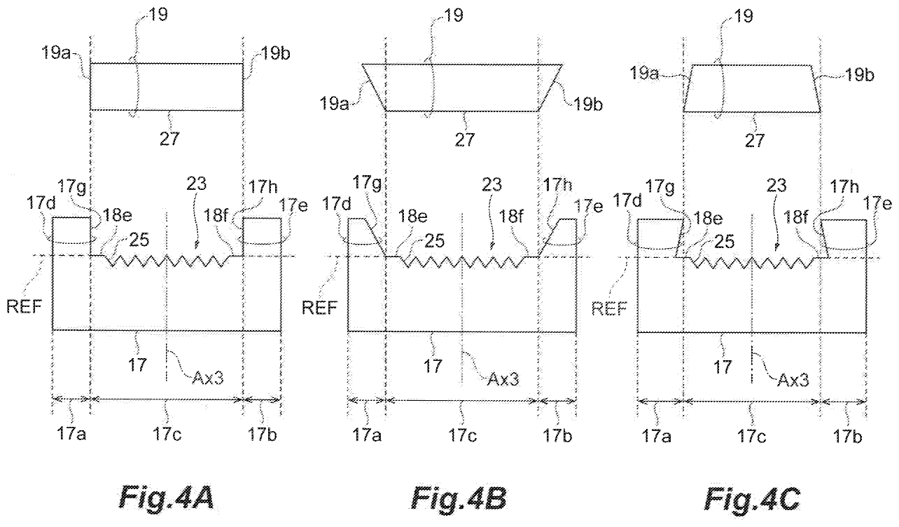

Each of FIG. 4A, 4B, and 4C is a view illustrating the first ridge and the second ridge of the first component, and the second component according to the present embodiment. The grooves 25 are arrayed along the reference surface REF.

With reference to FIG. 4A, each of the first inner side surface 17g of the first ridge 17d, the second inner side surface 17h of the second ridge 17e, and the first side surface 19a and the second side surface 19b of the second component 19 extends along each plane which is substantially perpendicular to the reference surface REF. A distance between the first side surface 19a and the second side surface 19b of the second component 19 (the width of the second component 19) is slightly smaller than a distance between the first inner side surface 17g of the first component and the second inner side surface 17h (a distance between the ridges).

As shown in FIG. 4B and FIG. 4C, each of the first inner side surface 17g of the first ridge 17d, the second inner side surface 17h of the second ridge 17e, and the first side surface 19a and the second side surface 19b of the second component 19 can extend along each plane which inclines with respect to the reference surface REF.

Specifically, with reference to FIG. 4B, each of the distance between the first inner side surface 17g of the first ridge 17d and the second inner side surface 17h of the second ridge 17e and the distance between the first side surface 19a and the second side surface 19b of the second component 19 can be gradually enlarged from a base of each of the first ridge 17d and the second ridge 17e toward a leading end of each of the first ridge 17d and the second ridge 17e, for example, in the direction of the third axis Ax3. A width of the supporting surface 27 of the second component 19 is slightly small, as compared with a width of the first area 17i (a distance between the first ridge 17d and the second ridge 17e in bases of the first ridge 17d and the second ridge 17e).

In addition, with reference to FIG. 4C, each of the distance between the first inner side surface 17g of the first ridge 17d and the second inner side surface 17h of the second ridge 17e and the distance between the first side surface 19a and the second side surface 19b of the second component 19 can be gradually enlarged from the leading end of each of the first ridge 17d and the second ridge 17e toward the base of each of the first ridge 17d and the second ridge 17e, for example, in the direction of the third axis Ax3. The width of the supporting surface 27 of the second component 19 is slightly small, as compared with a width of the first area 17i (a distance between the first ridge 17d and the second ridge 17e in upper ends of the first ridge 17d and the second ridge 17e),

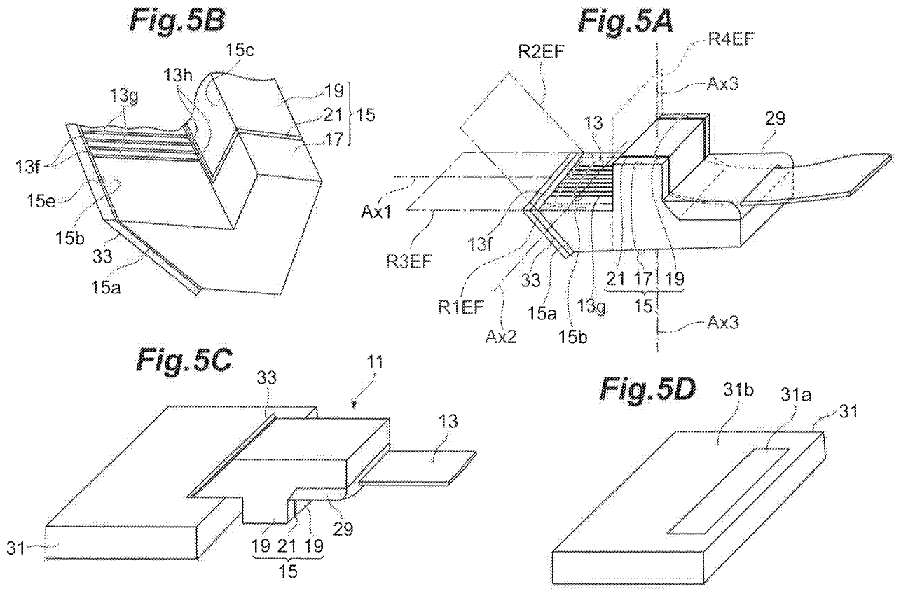

Each of FIG. 5A, FIG. 5B, and FIG. 5C is a view illustrating the optical connecting device according to the present embodiment.

With reference to FIG. 5A and FIG. 5B, the optical fibers 13 are arrayed along a first reference surface R1EF which crosses the third axis Ax3. The holder 15 has a front end surface 15a which extends along a second reference surface R2EF which crosses the first reference surface R1EF. Each of the optical fibers 13 has an end portion 13f which is located on the front end surface 15a.

Each of the optical fibers 13 has a clad side surface 13g which extends from an end portion 13f of each of the optical fibers 13 along a third reference surface R3EF which crosses the second reference surface R2EF. The clad side surface 13g is away from a core of each of the optical fibers 13. In addition, the holder 15 has a bottom end surface 15b which extends from the front end surface 15a along the third reference surface R3EF. The end portion 13f of each of the optical fibers 13 is arrayed in an acute angle end 15e at which the front end surface 15a and the bottom end surface 15b meet each other.

Each of the optical fibers 13 has a clad end surface 13h which extends along a fourth reference surface R4EF crossing the first axis Ax1 and is away from the end portion 13f of each of the optical fibers 13. In addition, the holder 15 has a side end surface 15c which is away from the front end surface 15a along the fourth reference surface R4EF. The bottom end surface 15b connects the front end surface 15a to the side end surface 15c. The front end surface 15a can form an angle in a range of 30 to 60 degrees with respect to the bottom end surface 15b.

The side end surface 15c can form an angle in a range of 90 to 135 degrees with respect to the bottom end surface 15b. Where needed, the optical connecting device 11 comprises a light reflecting component 33 on the front end surface 15a. The light reflecting component 33 includes, for example, a highly reflecting film such as a gold film.

With reference to FIG. 5C, the optical connecting device 11 is optically coupled via the clad side surface 13g to an optical coupling element 31a of a semiconductor optical device 31.

With reference to FIG. 5D, the semiconductor optical device 31 has the optical coupling element 31a such as an optical coupler, which is optically coupled to the end portion 13f of each of the optical fibers 13 of the optical connecting device 11, on a principal surface 31b.

According to the optical connecting device 11, the array of the end portions 13f of the optical fibers 13 is optically coupled via the clad side surface 13g to an external device.

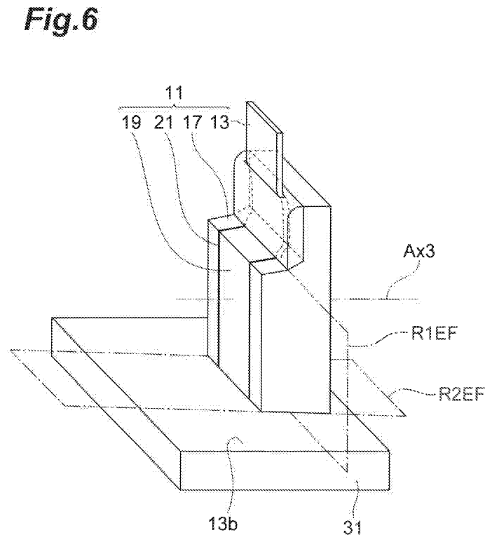

FIG. 6 is a view illustrating the optical connecting device and the optical device according to the present embodiment. The optical fibers 13 are arrayed along the first reference surface R1EF which crosses the third axis Ax3. The holder 15 has the front end surface 15a which extends along the second reference surface R2EF which crosses the first reference surface R1EF. The front end surface 15a can incline in such a way as to form an angle, for example, in a range of 60 to 90 degrees with respect to the first reference surface R1EF. The first component 17 and the second component 19 extend from the front end surface 15a of the holder 15 in a direction which crosses the principal surface 31b of the semiconductor optical device 31. Each of the optical fibers 13 has the end portion 13f which is located on the front end surface 15a.

According to the optical connecting device 11, the array of the end portions 13f of the optical fibers 13 is optically coupled to the external device. Specifically, the optical connecting device 11 is optically coupled via the front end surface 15a to the optical coupling element 31a, such as the optical coupler, of the semiconductor optical device 31 such as a silicon photonics element.

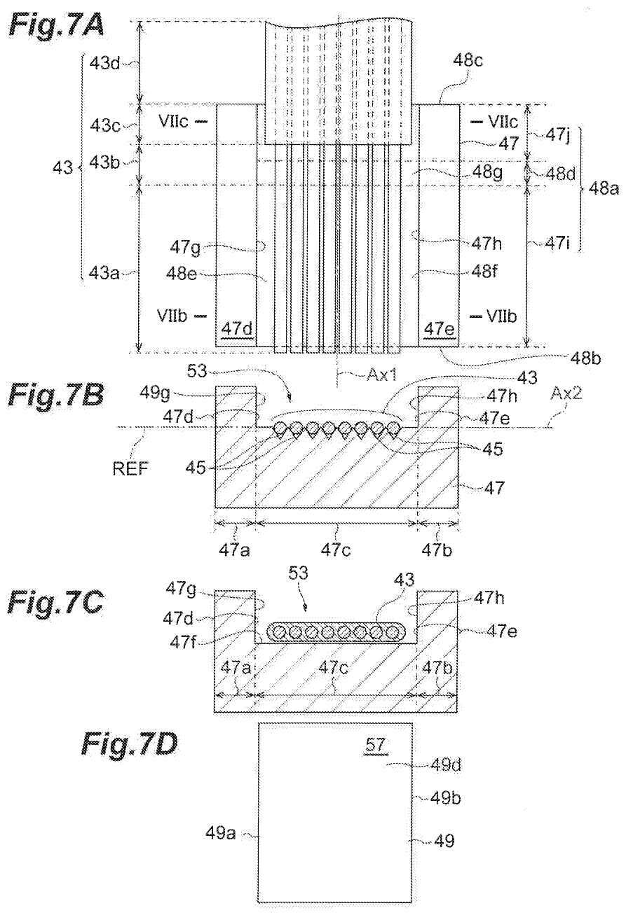

With reference to FIGS. 7A, 7B, 7C, 7D, 8A, 8B, 8C, 9A, 9B, 9C, 10A, 10B and 10C, main steps of a method for manufacturing the optical connecting device according to the present embodiment will be described.

FIG. 7A is a plan view illustrating a first member and an optical fiber component for the optical connecting device. FIG. 7B is a view illustrating a cross section taken along line VIIb-VIIb shown FIG. 7A.

FIG. 7C is a view illustrating a cross section taken along line VIIc-VIIc shown in FIG. 7A. FIG. 7D is a plan view illustrating a second member for the optical connecting device.

An optical fiber component 43 for the optical fibers 13 and the first member 47 and the second member 49 for the first component 17 and the second component 19 are prepared. Each of the optical fiber component 43 includes a first bare wire fiber part 43a, a second hare wire fiber part 43b, a first covered fiber part 43c, and a second covered fiber part 43d. The first bare wire fiber part 43a, the second bare wire fiber part 43b, the first covered fiber part 43c, and the second covered fiber part 43d are arrayed in a direction of a waveguide axis.

The first member 47 includes a first outer part 47a, a second outer part 47b, and an inner part 47c. The first outer part 47a and the second outer part 47b have a first ridge 47d and a second ridge 47e, respectively. The optical fiber component 43, the first outer part 47a, and the second outer part 47b extend in a direction of a first axis Ax1. The first outer part 47a, the inner part 47c, and the second outer part 47b are arrayed in a direction of a second axis Ax1 which crosses the first axis Ax1. The inner part 47c has a bottom 47f of a recess 53, which is defined by the first ridge 47d and the second ridge 47e.

The first member 47 has a plurality of grooves 45 which extend in the direction of the first axis Ax1. The grooves 45 are provided in the bottom 47f of the recess 53. The second member 49 has a supporting surface 57 which is substantially flat. Each of the grooves 45 has a cross section, for example, which is V-shaped.

The first member 47 has a principal surface 48a, a front end 48b, and a rear end 48c. In the first member 47, the principal surface 48a has a step difference 48d, a first area 47i, and a second area 47j. The first area 47i is located in the inner part 47c. The first area 47i, the step difference 48d, and the second area 47j are arrayed in the direction of the first axis Ax1. The step difference 48d has a sloping surface 48g which connects the first area 47i to the second area 47j.

The first area 47i extends from the front end 48b to the step difference 48d in the direction of the first axis Ax1 and connects a first inner side surface 47g of the first ridge 47d to a second inner side surface 47h of the second ridge 47e. The grooves 45 are provided in the first area 47i and are terminated at the step difference 48d. The second area 47j is substantially flat. The second area 47j extends from the step difference 48d to a rear end 18c in the direction of the first axis Ax1. The first ridge 47d and the second ridge 47e extend from the front end 48b to the rear end 48c. Where needed, the first ridge 47d and the second ridge 47e can be terminated between the front end 48b and the rear end 48c, for example, at a position of the step difference 48d.

In the first area 47i, a first flat surface 48e and a second flat surface 48f extend along a reference surface REF which crosses a third axis Ax3. The grooves 45 are located below the reference surface REF, and the first ridge 47d and the second ridge 47e are located above the reference surface REF.

The optical fiber component 43 is placed in the grooves 45 of the first member 47. Specifically, the first bare wire fiber part 43a is placed in each of the grooves 45 of the first area 47i, and the second bare wire fiber part 43b and the first covered fiber part 43c are placed on the second area 47j. The second covered fiber part 43d extends out from the rear end 48c of the first member 47.

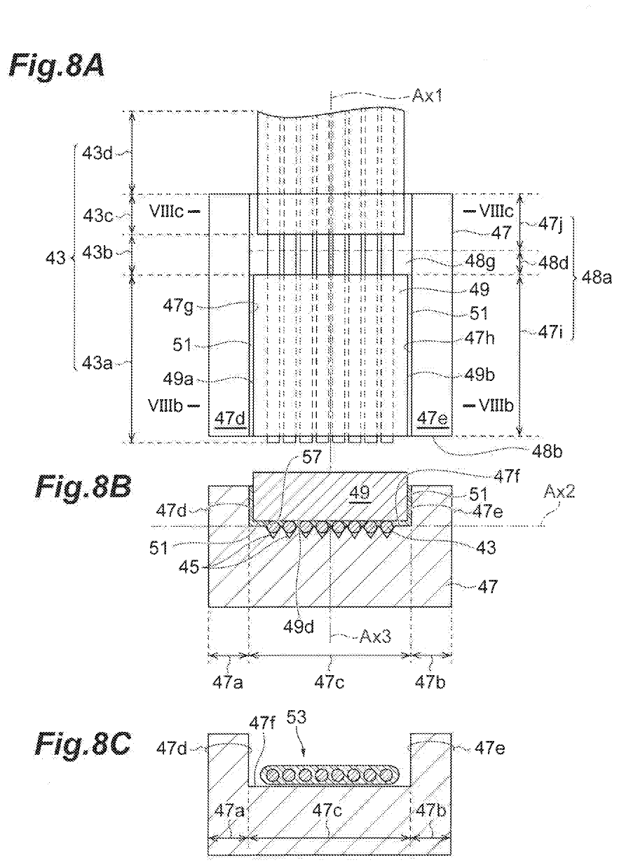

FIG. 8A is a plan view illustrating the first member, the second member, and the optical fiber component which are preliminarily assembled. FIG. 8B is a view illustrating a cross section taken along line shown in FIG. 8A. FIG. 8C is a view illustrating a cross section taken along a line VIIIc-VIIIc shown in FIG. 8A.

The second member 49 is located between the first ridge 47d of the first outer part 47a and the second ridge 47e of the second outer part 47b. The optical fiber component 43 is arrayed between the bottom 47f of the first member 47 and the supporting surface 57 of the second member 49. An adhesive 51 is supplied on the optical fiber component 43 on the first member 47, and the supporting surface 57 of the second member 49 is pressed against the optical fiber component 43. The adhesive 51 can include, for example, an ultraviolet curing agent and/or a thermosetting agent.

Specifically, the second member 49 is inserted between the first ridge 47d and the second ridge 47e, and the optical fiber component 43 which is oriented by the grooves 45 of the first member 47 is held down by a bottom surface 49d of the second member 49.

By the insertion of the second member 49, the adhesive 51 is provided between the first member 47 and the second member 49 and is moved along the first inner side surface 47g of the first ridge 47d, the second inner side surface 47h of the second ridge 47e, and a first side surface 49a and a second side surface 49b of the second member 49. Specifically, the adhesive 51 is provided between the first member 47 and the second member 49, and an uncured surplus portion of the adhesive flows into a space between the first inner side surface 47g and the first side surface 49a and a space between the second inner side surface 47h and the second side surface 49b along the directions of the first axis Ax1 and third axis Ax3.

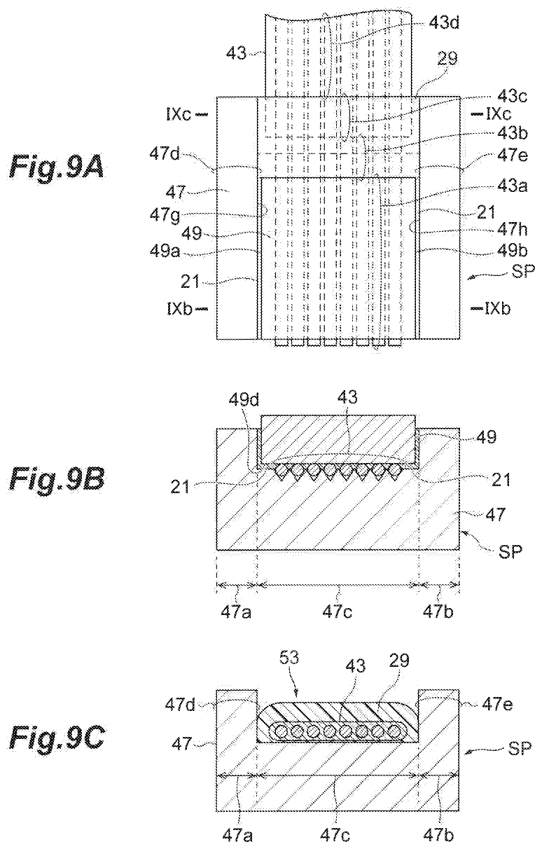

FIG. 9A is a plan view illustrating the first member, the second member, and the optical fiber component which are fixed by the adhesive. FIG. 9B is a view illustrating a cross section taken along line IXb-IXb shown in FIG. 9A. FIG. 9C is a view illustrating a cross section taken along line IXc-IXc shown in FIG. 9A.

With the above-mentioned holding-down maintained, by solidifying the adhesive 51, the solidified adhesive 51 is formed. Thus, an intermediate product SP can be obtained. In the intermediate product SP, the optical fiber component 43 is fixed between the first member 47 and the second member 49. The optical fiber component 43 protrudes from a leading end surface of the intermediate product SR

The solidified adhesive 51 is provided between the bottom 47f of the first member 47 and the second member 49, between the first inner side surface 47g of the first ridge 47d and the first side surface 49a of the second member 49, and between the second inner side surface 47h of the second ridge 47e and the second side surface 49b of the second member 49 and fixes the optical fiber component 43, the first member 47, and the second member 49. The first member 47 and the second member 49 are fixed, and as a result, the optical fiber component 43 is fixed between the inner part 47c of the first member 47 and the bottom surface 49d of the second member 49. Where needed, the resin body 29 is formed on the optical fibers (43b and 43c).

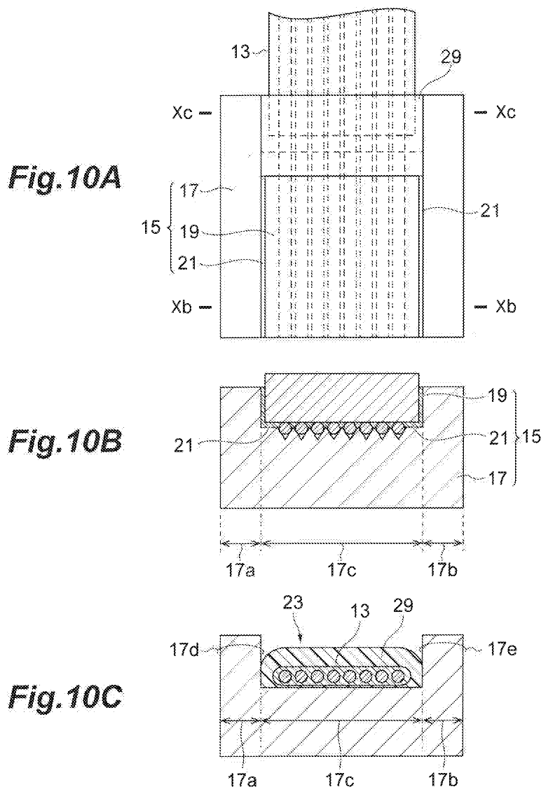

FIG. 10A is a plan view illustrating an optical connecting device processed by machining. FIG. 10B is a view illustrating a cross section taken along line Xb-Xb shown in FIG. 10A. FIG. 10C is a view illustrating a cross section taken along line Xc-Xc shown in FIG. 10A.

The intermediate product SP is subjected to desired machining, thereby manufacturing the optical connecting device 11. In this example, the leading end surface of the intermediate product SP is polished, thereby forming the front end surface 15a which enables optical coupling. By this polishing, the protruding leading end of the optical fiber component 43 is vanished.

Through these processes, the optical connecting device 11 shown in FIG. 6 is completed. For the manufacturing of the optical connecting device 11 shown in FIGS. 5A, 5B and 5C, additional processes may be conducted, thereby allowing the clad side surface 13g and the clad end surface 13h to be formed.

In the preferred embodiment, the principles of the present invention are described through the illustration with reference to the accompanying drawings. However, it is recognized by those skilled in the art that the present invention can be modified in disposition and in details without departing from the above-described principles. The present invention is not limited to the particular configuration disclosed in the present embodiment. Accordingly, rights to all alterations and modifications coming within the scope of the appended claims and the scope of the spirit thereof are claimed.

What is claimed is:

1. An optical connecting device comprising:
a holder including
a first component including a first outer part having a first ridge, a second outer part having a second ridge and an inner part having a bottom of a recess being defined by the first ridge and the second ridge,
a second component being located between the first ridge of the first outer part and the second ridge of the second outer part, and
an adhesive member being provided between the first component and the second component; and
a plurality of optical fibers being arrayed between the bottom of the first component and the second component, wherein
the optical fibers, the first ridge, and the second ridge extend in a direction of a first axis, and
the first outer part, the inner part, and the second outer part are arrayed in a direction of a second axis crossing the first axis.

2. The optical connecting device according to claim 1, wherein
the first component has, in the bottom of the recess, a plurality of grooves extending in the direction of the first axis,
the second component has a supporting surface, and
the optical fibers are positioned by the grooves of the first component and the supporting surface of the second component.

3. The optical connecting device according to claim 2, wherein
the first component has a step difference terminating the grooves,
the inner part of the first component has a first area and a second area, the first area and the second area being arrayed in the direction of the first axis,
the step difference has a sloping surface connecting the first area to the second area,
the second component is located on the first area, and
each of the optical fibers has a first fiber part extending between the first area of the first component and the second component of the holder and a second fiber part extending in the second area of the holder.

4. The optical connecting device according to claim 1, wherein
the optical fibers are arrayed along a first reference surface crossing a third axis crossing the first axis and the second axis,
the holder has a front end surface extending along a second reference surface crossing the first reference surface,
the first component and the second component extend from the front end surface in the direction of the first axis, and
each of the optical fibers has an end portion being located on the front end surface.

5. The optical connecting device according to claim 1, wherein
the optical fibers are arrayed along a first reference surface crossing a third axis crossing the first axis and the second axis,
the holder has a front end surface extending along a second reference surface inclining with respect to the first reference surface,
each of the optical fibers has an end portion being located on the front end surface,
each of the optical fibers has a clad side surface extending along a third reference surface crossing the third axis, the clad side surface being away from the end portion, and
each of the optical fibers has a clad end surface extending along a fourth reference surface crossing the first axis, the clad end surface being away from the end portion.
